(19) United States
(12) Patent Application Publication
(10) Pub. No.: US 2026/0245441 A1
(43) Pub. Date: Aug. 20, 2026

(54) DRONE-BASED CROWD DENSITY DETECTION AND ACCIDENT PREVENTION SYSTEM

(71) Applicant: Industry-University Cooperation Foundation Sunmoon University, Asan-si (KR)

(72) Inventors: Minsoo KANG, Asan-si (KR); Jonghwan YUN, Pyeongtaek-si (KR); Jiho SHIN, Asan-si (KR); Myungmook KANG, Daejeon (KR); Hanghyeon JO, Cheonan-si (KR); Siyun YU, Cheonan-si (KR)

(73) Assignee: Industry-University Cooperation Foundation Sunmoon University, Asan-si (KR)

(21) Appl. No.: 19/057,115

(22) Filed: Feb. 19, 2025

(30) Foreign Application Priority Data
Feb. 17, 2025 (KR) 10-2025-0020291

(51) Int. Cl. G08B 7/06; G05D 1/611; G05D 105/70; G05D 107/17; G05D 109/20; G05D 111/10; G06V 20/17; G06V 20/52; G06V 40/16; G06V 40/20; G08B 21/02

(52) U.S. Cl. CPC G08B 7/066; G05D 1/611; G06V 20/17; G06V 20/53; G06V 40/172; G06V 40/174; G06V 40/25; G08B 21/02; G05D 2105/70; G05D 2107/17; G05D 2109/20; G05D 2111/10

(57) ABSTRACT

A drone-based crowd density detection and accident prevention system according to various embodiments of the present invention is disclosed. The system includes a drone device that includes an image acquisition unit acquiring image data for detecting crowd density in real time, and a control server that generates risk level determination information based on the image data collected by the drone device, determines a response level according to a real-time change in the risk level determination information, generates a warning control signal corresponding to the determined response level, and transmits the generated warning control signal to at least one of an external device and the drone device.

### CROSS-REFERENCE TO RELATED APPLICATION

This application claims priority to and the benefit of Korean Patent Application No. 10-2025-0020291, filed on Feb. 17, 2025, the disclosure of which is incorporated herein by reference in its entirety.

### BACKGROUND

### 1. Field of the Invention

The present invention relates to a drone-based crowd density detection and accident prevention system and method, and more particularly, to a crowd safety management method of analyzing a movement pattern of a crowd using real-time image analysis and environmental detection data, assessing a risk level, and providing guidance on an evacuation route.

### 2. Discussion of Related Art

Accident prevention in a crowded area is considered an important issue in environments where a large number of people are concentrated, such as large-scale events, sports games, performance halls, public transportation hubs, rallies, and disaster evacuation situations. In particular, in an area with high population density, when a crowd is abnormally concentrated or moves rapidly in a specific direction, there is a high possibility of serious safety accidents such as injury due to crushing, collision, and crowding. To solve this problem, a method of monitoring crowd density using a CCTV-based surveillance system and deploying security personnel to respond when dangerous situations occur has been mainly used.

However, the existing crowd density detection and accident prevention technologies have several limitations. Since the CCTV surveillance system captures images only at a fixed location, it is difficult to variably expand the detection range according to the movement of the crowd. In addition, immediate risk detection and response is difficult with a method of humans directly monitoring crowd density, and analyzing a plurality of surveillance screens in real time is limited by human resources. Some systems are introducing automated algorithms that analyze crowd density based on image data, but most of the automated algorithms remain at the level of simply calculating a density of a specific area, and lack the ability to detect moving flows of crowds or abnormal behaviors of individual objects that change in real time.

In addition, the existing systems mainly focus on a change in crowd density, so there is a problem in that the existing systems may not reflect the impact of changes in a surrounding environment on accident occurrence in real time. For example, when illuminance decreases or noise increases rapidly, an emotional response of a crowd may change, which may cause a sudden panic situation, but the function of detecting and responding to these factors in real time is insufficient. In addition, a function of dynamically adjusting a risk by considering factors such as a slope of a terrain, congestion of an entrance, and locations of obstacles is insufficient, making it difficult to efficiently lead a crowd to safely evacuate.

### SUMMARY OF THE INVENTION

The present invention is directed to providing a system and method for detecting crowd density, assessing a risk factor, and performing an appropriate response in real time to prevent accidents and induce safe movement in an environment where a crowd is dense.

Problems of the present invention are not limited to the above-described problems. That is, other problems that are not described may be obviously understood by those skilled in the art from the following description.

To solve the above-described problems, a drone-based crowd density detection and accident prevention system according to an embodiment of the present invention is disclosed. The system may include a drone device that includes an image acquisition unit acquiring image data for detecting crowd density in real time, and a control server that generates risk level determination information based on the image data collected by the drone device, determines a response level according to a real-time change in the risk level determination information, generates a warning control signal corresponding to the determined response level, and transmits the generated warning control signal to at least one of an external device and the drone device.

In an alternative embodiment, the drone device may include an information display unit, and the information display unit may include a display panel and a light emitting diode (LED) warning light for providing a visual warning and an evacuation guidance signal to a crowd according to the risk level determination information, and may intuitively display a crowd density state by using a color change according to the risk level through at least one of the display panel and the LED warning light, and visually provides an evacuation direction or safety zone information.

In an alternative embodiment, the control server may include an analysis module that generates the risk level determination information based on the image data, and the analysis module may include an object detection and crowd flow analysis unit that identifies an individual in the crowd from the image data and analyzes a movement route and a congested zone, a density assessment unit that quantitatively calculates the crowd density and generates density information by assessing whether a risk threshold value is exceeded within a specific zone, an emotional state analysis unit that analyzes a facial expression and a physical movement of an individual to generate emotional state information, and a risk level determination unit that integrates the density information and the emotional state information to predict a dynamic change in the crowd and detect an abnormal pattern.

In an alternative embodiment, the control server may include a flight pattern control unit that adjusts a flight pattern of the drone device in real time in a specific crowd area based on the risk level determination information, and the flight pattern control unit may control the drone device to perform precision detection by switching to a low-altitude flight mode when the density information corresponding to a specific zone exceeds a preset threshold value, control the drone device to hover at a fixed location within a safe distance when it is identified that a tension and fear response of the crowd rapidly increases based on the real-time change in the emotional state information corresponding to the image data acquired while the precision detection is performed, and control the drone device to continuously collect additional image data in a corresponding zone when the crowd density continues to increase or a congested state is maintained for a certain period of time, as a result of analyzing the image data collected in the low-altitude flight and hovering state.

In an alternative embodiment, the density assessment unit may dynamically adjust a risk threshold value for assessing the crowd density according to environmental factors, and the environmental factors may include spatial density related to identifying an individual in the crowd from the image data and calculating people per unit square meter (PPD) based on an area of a zone where the crowd is located, obstacle influence related to assessing a degree to which a movable route of the crowd is restricted by analyzing a location, size, and width of an obstacle, terrain slope information related to analyzing a terrain slope of the zone where the crowd is located and adjusting a risk when the terrain slope is a certain slope or more, and escape possibility information related to assessing a possibility of risk avoidance of the crowd by analyzing whether an entry and evacuation route is secured.

In an alternative embodiment, the risk level determination unit may classify a plurality of crowd groups having different properties based on an individual movement pattern of the crowd within the same zone, the plurality of crowd groups may include a moving crowd group that includes a crowd moving in the same direction at a constant speed, a congested crowd group that includes a crowd that is congested at a specific point or remains in a high density state for a certain period of time, an abnormal behavior crowd group that includes a crowd that exhibits a sudden change in direction, an irregular change in speed, or an unpredictable movement compared to a previous movement route, and an individual crowd group that includes a crowd that moves individually while away from other crowds by a certain distance or more, and the risk level determination unit may apply different risk levels to each of the plurality of crowd groups, and when a specific crowd group is determined to have a relatively high risk compared to the entire crowd, preferentially monitor the corresponding crowd group or adjusts the flight pattern of the drone device.

In an alternative embodiment, when the control server detects that the risk level determination information is greater than a reference threshold value, the control server may generate evacuation route information based on map information related to an area where the crowd is located and location information of the drone device, and dynamically correct the evacuation route information based on the risk levels of each of the plurality of classified crowd groups.

In an alternative embodiment, the risk level determination unit may analyze a movement speed change, a congestion duration, and a behavioral pattern of each crowd group in real time, and when it is identified that at least one of a plurality of conditions is satisfied, increase a risk level of a specific area, the plurality of conditions including a first condition in which the speed reduction rate of the moving crowd group exceeds a preset threshold speed reduction rate, a second condition in which the congested crowd group remains at the same location for a preset period of time or longer, and a third condition in which the irregular change in speed or the sudden change in direction is detected within the moving crowd group or the individual crowd group and switching to the abnormal behavior crowd group is detected.

In an alternative embodiment, the risk level determination unit may analyze a movement speed, a movement direction, a physical movement, and an emotional state of the individual in real time to detect an abnormal crowd exhibiting abnormal behavior, track a movement route of the abnormal crowd, and dynamically adjust a risk level of a zone where the abnormal crowd is located according to a state of the abnormal crowd.

In an alternative embodiment, the drone device may include a directional speaker unit that outputs voice information for movement and evacuation guidance of a crowded area and each partitioned individual zone, and the directional speaker unit may detect crowd density and an environmental noise level in real time, automatically adjust sound output intensity, and dynamically adjust a direction of a sound output in response to the movement route of the crowd.

Other detailed content of the present invention is described in a detailed description and illustrated in the drawings.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram schematically illustrating a drone-based crowd density detection and accident prevention system according to an embodiment of the present invention;

FIG. 2 is a hardware configuration diagram of a control server that performs a crowd density detection and accident prevention method according to an embodiment of the present invention;

FIG. 3 is an exemplary diagram illustrating an information display process of a drone device according to an embodiment of the present invention; and

FIG. 4 is an exemplary flowchart related to the crowd density detection and accident prevention method performed through the control server according to an embodiment of the present invention.

### DETAILED DESCRIPTION OF EXEMPLARY EMBODIMENTS

Hereinafter, various embodiments will be described with reference to the drawings. In this specification, various descriptions are presented to provide an understanding of the invention. However, it is obvious that these embodiments may be practiced without these specific descriptions.

The terms “component,” “module,” “system,” etc., used herein refer to a computer-related entity, hardware, firmware, software, a combination of software and hardware, or an implementation of software. For example, a component may be, but is not limited to, a process running on a processor, a processor, an object, an execution thread, a program, and/or a computer. For example, both an application running on a computing device and the computing device may be a component. One or more components may reside within a processor and/or execution thread. One component may be localized within one computer. One component may be distributed between two or more computers. In addition, these components may be executed from various computer-readable media having various data structures stored therein. Components may communicate via local and/or remote processes (e.g. data from one component interacting with other components in a local system and a distributed system and/or data transmitted to other systems through signals via networks such as the Internet), for example according to signals with one or more data packets.

In addition, the term “or” is intended to mean an inclusive “or,” not an exclusive “or.” That is, unless otherwise specified or clear from context, “X uses A or B” is intended to mean one of the natural implicit substitutions. That is, “X uses A or B” may describe any of the cases in which X uses A, X uses B, and X uses both A and B. In addition, the term “and/or” used herein should be understood to refer to and include all possible combinations of one or more of the related items listed.

In addition, the terms “include” and/or “including” should be understood to mean that the corresponding feature and/or component is present. However, the terms “include” and/or “including” should be understood as not excluding the presence or addition of one or more other features, components and/or groups thereof. In addition, unless otherwise specified or the context clearly indicates a singular entity, a singular form in the present specification and in the claims should generally be construed to mean “one or more.”

Those skilled in the art should recognize that various illustrative logical blocks, configurations, modules, circuits, means, logic, algorithms, and steps described in connection with the embodiments disclosed herein may be implemented by electronic hardware, computer software, or a combination of both. To clearly illustrate interchangeability of hardware and software, various illustrative components, blocks, configurations, means, logics, modules, circuits, and steps have been described above generally in terms of their functionality. Whether such functionality is implemented by hardware or software will depend on the specific application and design constraints imposed on the overall system. Those skilled in the art may implement the described functionality in a variety of ways for each specific application. However, such implementation determinations should not be construed as departing from the scope of the present invention.

The description of the presented embodiments is provided to enable those skilled in the art to make or use the present invention. Various modifications to these embodiments will be apparent to those skilled in the art. The general principles defined herein may be applied to other embodiments without departing from the scope of the invention. Therefore, the present invention is not limited to the embodiments presented herein. The present invention should be interpreted in the broadest scope consistent with the principles and novel features presented herein.

In this specification, “computer” means all kinds of hardware devices including at least one processor, and can be understood as including a software configuration which is operated in the corresponding hardware device according to the embodiment. For example, “computer” may be understood to include all of smart phones, tablet PCs, desktops, laptops, and user clients and applications running on each device, but is not limited thereto.

Hereinafter, embodiments of the present invention will be described in detail with reference to the accompanying drawings.

Each step described in this specification is described as being performed by the computer, but subjects of each step are not limited thereto, and according to embodiments, at least some steps can also be performed on different devices.

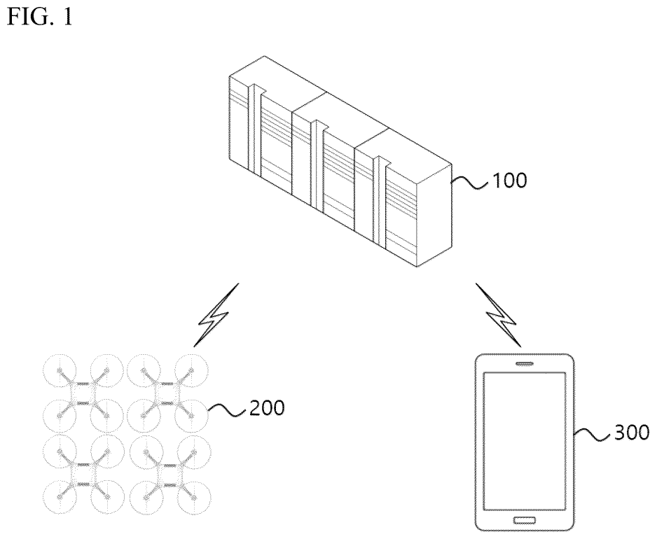

FIG. 1 is an exemplary diagram schematically illustrating a drone-based crowd density detection and accident prevention system according to an embodiment of the present invention.

As illustrated in FIG. 1, a system according to embodiments of the present invention may include a control server 100, a drone device 200, a user terminal 300, and a network. The components illustrated in FIG. 1 are exemplary, and additional components may exist or some of the components illustrated in FIG. 1 may be omitted. The control server 100, the drone device 200, and the user terminal 300 according to embodiments of the present invention may mutually transmit and receive data for the system according to embodiments of the present invention through a network.

The control server 100 (hereinafter referred to as “control server 100”) that performs a crowd density detection and accident prevention method according to an embodiment of the present invention may be linked to the drone device 200 and the user terminal 300 to perform a function of assessing crowd density, determining a risk level, and providing a warning signal or a control signal for a warning in real time.

The control server 100 may analyze image data and environmental data acquired from the drone device 200 to assess crowd density, movement flow, emotional state, etc., and generate risk level determination information based on the assessed crowd density, movement flow, emotional state, etc. In addition, based on the risk level determination information, a warning control signal may be generated, an optimal route for evacuation guidance of a crowd may be calculated as needed, and the corresponding information may be transmitted through an information display unit of the user terminal 300 or the drone device 200.

In an embodiment, the control server 100 may dynamically adjust a response strategy by reflecting behavioral patterns and environmental factors of a crowd that change in real time, and determine and provide a warning level appropriate for each situation based on a plurality of warning signal classification values. Accordingly, it is possible to more effectively perform crowd management and accident prevention at large-scale events where a crowd is dense or in emergency situations.

In an embodiment, only one control server 100 is illustrated in FIG. 1, but it will be apparent to those skilled in the art that more computing devices may also be included in the scope of the present invention and that the control server 100 may include additional components. That is, the control server 100 may be composed of a plurality of computing devices (or servers). In other words, a set of nodes may constitute the control server 100.

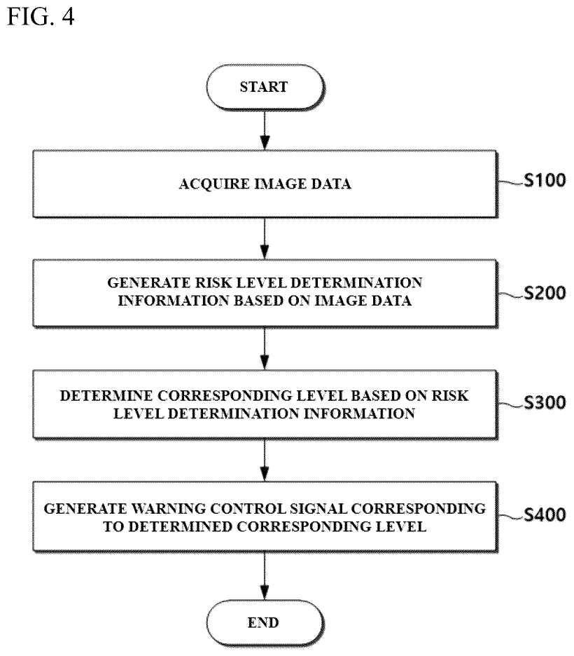

The crowd density detection and accident prevention method provided by the control server 100 and the effects caused thereby will be described below in detail with reference to FIG. 4.

According to an embodiment, the drone device 200 may be operated as a single device, or may be configured as a plurality of devices for more precise crowd density detection and accident prevention. When the plurality of drone devices 200 are operated, each drone device may be in charge of a designated zone and individually collect data or cooperatively detect and respond to crowd density situations.

When the plurality of drone devices 200 are provided, if the crowd density increases or the abnormal behavior is detected within a specific zone, the drone device in charge of the corresponding zone may output an immediate warning signal, and if necessary, may include additional drone devices to perform precise detection. For example, when the plurality of drone devices 200 are arranged at a large-scale event venue, each drone device may assess crowd density in real time within the designated zone for which it is responsible, perform emotion analysis, and analyze a movement flow of a crowd to detect abnormal situations.

The drone device 200 may be linked to the control server 100 in real time to transmit and receive data and share crowd density and risk level determination information. For example, when the crowd density increases rapidly and the congestion occurs in the specific zone, the corresponding data may be transmitted to the control server 100 to update the risk level determination information and provide guidance information to induce movement to another zone with smooth crowd flow.

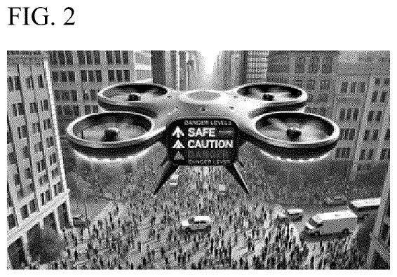

In an embodiment, the information display may be performed through a display panel, an LED warning light, and a directional speaker with which the drone device 200 is equipped, as illustrated in FIG. 2, and if necessary, may be linked to the user terminal 300 to provide customized warning information to individual users. For example, the display panel of the drone device 200 may visually display a crowd density and evacuation direction of a current location, and the LED warning light may notify of a risk level through a color change so that the crowd may recognize the crowd density and evacuation direction from a distance.

In addition, by transmitting a warning message only in a specific direction using the directional speaker, it is possible to effectively perform the evacuation guidance while preventing unnecessary confusion in a crowded area. For example, when the crowd density increases at a stadium exit, the drone device 200 may provide a guidance message such as “This exit is crowded. Please use the opposite exit,” through the directional speaker.

In an embodiment, when the drone device 200 is linked to the user terminal 300, the real-time warning messages may be checked on smartphones, tablets, or wearable devices of each user, and a GPS-based evacuation route guidance service may also be provided. For example, when a zone where a user is currently located is determined to have a high risk level, the control server 100 may transmit evacuation route guidance information to the user terminal 300 to induce safe movement.

The linked operation method with the plurality of drone devices 200 and the control server 100 is differentiated in that it effectively supports the safe movement of the crowd by determining the risk level in real time, establishing an optimal response strategy, and providing information in various ways, beyond the simple crowd density detection. Accordingly, it is possible to more effectively perform the real-time crowd management and accident prevention in various environments such as large-scale event venues, urban areas, and transportation hubs.

In FIG. 1, the control server 100 and the drone device 200 are separately configured and illustrated, but according to an embodiment of the present invention, the two components may be operated in an integrated manner.

According to an embodiment of the present invention, the control server 100 performs a central control role of the crowd density detection and accident prevention system, and may be configured to transmit and receive data in real time with the plurality of drone devices 200 through the network. However, in some embodiments, the function of the control server 100 may be directly installed in the drone device 200, so that individual drones may be utilized as AI drones that independently perform the crowd density detection and accident prevention function.

For example, in an environment where cloud-based centralized control is required, the plurality of drone devices 200 may be connected to the control server 100 to process data and determine the risk level in real time. On the other hand, when the network connection is limited or a rapid response is required in a specific area, the drone device 200 may be equipped with the function of the control server 100, and individual drones may generate a risk determination and generate warning signal based on AI.

In addition, such an integrated AI drone may perform real-time image data processing and analysis functions on its own, and may detect the crowd density state without the network connection, determine the risk situation, and provide the immediate warning. For example, when the AI drone detects the rapid increase in crowd density in the specific zone, the AI drone may immediately output the warning signal and provide guidance on the evacuation direction without central control. The integrated operation method enables effective crowd management, especially in an environment where emergency response is required or an area where network connectivity is limited, and enables autonomous accident prevention and response using the AI drone.

The user terminal 300 according to the embodiment of the present invention may be any type of node(s) in a system having a mechanism capable of communicating with the control server 100.

The user terminal 300 is a terminal that may receive the crowd density state, the risk level determination information, and the evacuation route guidance information through the information exchange with the control server 100, and may include a mobile device carried by a user.

For example, the user terminal 300 may include a smartphone, a tablet, a wearable device, etc., that may receive the safety warning and evacuation guidance in the environment where a crowd is dense. The user may confirm the risk level of the current location through his/her terminal, and receive the optimal movement route and evacuation guidance.

In addition, the user terminal 300 may be utilized as a monitoring device of an organization in charge of the crowd management and accident prevention (e.g., police, fire department, event manager). In this case, the manager may confirm the real-time crowd density state, abnormal behavior detection information, and emergency response route through the user terminal 300, and if necessary, execute additional safety measures.

In an additional embodiment, the user terminal 300 includes a display, and may receive user input and output real-time warning information, evacuation guidance, or individually customized warning messages.

The user terminal 300 may be implemented as various types of devices within a system capable of communicating with the control server 100. For example, the user terminal 300 may include a personal computer (PC), a laptop, a mobile terminal, a smartphone, a tablet PC, a wearable device, etc., and may include all types of terminals capable of accessing wired and wireless networks. In addition, the user terminal 300 may include an application-based system, and may be implemented in an application programming interface (API) or a plug-in form.

In an embodiment of the present invention, the user terminal 300 may be utilized to provide real-time safety warnings to individual users, or to induce safe movement of a large crowd by being linked to a crowd management system.

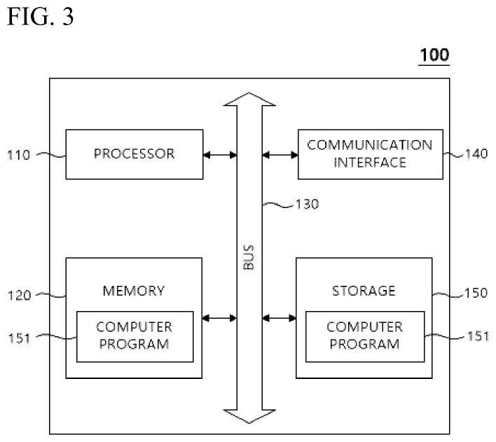

FIG. 3 is a hardware configuration diagram of the control server that performs a crowd detection and accident prevention method according to an embodiment of the present invention.

Referring to FIG. 3, the control server 100 according to an embodiment of the present invention may include one or more processors 110, a memory 120 into which a computer program 151 executed by the processor 110 is loaded, a bus 130, a communication interface 140, and a storage 150 for storing the computer program 151. Here, only the components related to the embodiment of the present invention are illustrated in FIG. 3. Accordingly, those skilled in the art to which the present invention pertains may understand that general-purpose components other than those illustrated in FIG. 3 may be further included.

According to an embodiment of the present invention, the processor 110 may generally process the overall operation of the control server 100. The processor 110 may provide or process appropriate information or functions for the user or user terminal by processing signals, data, information, and the like, which are input or output through the above-described components, or by driving an application program stored in the memory 120.

In addition, the processor 110 may perform calculations on at least one application or program for executing the method according to the embodiments of the present invention, and the control server 100 may include one or more processors.

According to an embodiment of the present invention, the processor 110 may be composed of one or more cores, and may include a processor for data analysis and deep learning, such as a central processing unit (CPU), a general purpose graphics processing unit (GPGPU), a tensor processing unit (TPU), etc., of a computing device.

The processor 110 may read the computer program stored in the memory 120 and perform the crowd density detection and accident prevention method according to the embodiment of the present invention.

In various embodiments, the processor 110 may further include a random access memory (RAM) and a read-only memory (ROM) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various data, commands, and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a random access memory (RAM), but the technical scope of the present invention is not limited thereto.

The bus 130 provides a communication function between the components of the control server 100. The bus 130 may be implemented as various types of buses, such as an address bus, a data bus, and a control bus.

The communication interface 140 supports wired/wireless Internet communication of the control server 100. In addition, the communication interface 140 may support various communication manners other than the Internet communication. To this end, the communication interface 140 may be configured to include a communication module well known in the art of the present invention. In some embodiments, the communication interface 140 may be omitted.

The storage 150 may non-temporarily store the computer program 151. When performing the crowd density detection and accident prevention process through the control server 100, the storage 150 may store various types of information necessary to provide the crowd density detection and accident prevention process.

The storage 150 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In an embodiment, the computer program 151 may include one or more instructions for performing a crowd density detection and accident prevention method, that includes acquiring image data, generating the risk level determination information based on the image data, determining a response level based on the risk level determination information, and generating a warning control signal corresponding to the determined response level.

Operations of the method or algorithm described with reference to the embodiment of the present invention may be directly implemented in hardware, in software modules executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a compact disc read-only memory (CD-ROM), or in any form of computer-readable recording media known in the art to which the invention pertains.

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, or an assembler, including various algorithms implemented in a combination of data structures, processes, routines, or other programming constructions. Functional aspects may be implemented in algorithms executed on one or more processors.

FIG. 4 is an exemplary flowchart related to the crowd detection and accident prevention method performed through the control server according to an embodiment of the present invention.

The order of the operations illustrated in FIG. 4 may be changed as needed, and at least one operation may be omitted or added. The operations of FIG. 4 are merely an embodiment of the present invention, and the scope of the rights of the present invention is not limited thereto.

According to an embodiment of the present invention, the crowd density detection and accident prevention method may include acquiring the image data (S100).

In an embodiment, the acquisition of the image data may be performed through an image acquisition unit included in the drone device 200, and a high-resolution camera may be used to capture real-time images of a zone where a crowd is dense. For example, when the drone device 200 flying at a high altitude detects the overall crowd flow and captures abnormal signs in a specific area (e.g., when a specific area is determined to have a high density), the drone device 200 may be switched to a low-altitude flight mode to acquire the image data in order to analyze the zone more precisely.

As another example, in a place with high crowd density, the plurality of drone devices 200 may be arranged cooperatively to collect the image data. For example, at a large-scale event venue, the plurality of drone devices 200 arranged at a main entrance, a main passageway, an expected crowded area, etc., may individually acquire data and analyze a crowd flow in real time.

In addition, the method of acquiring image data may be expanded to a method of detecting environmental factors (illumination change, smoke generation, etc.) by utilizing a multi-spectral sensor, in addition to simply capturing images through a camera. For example, at a nighttime event or in an indoor environment, it may be difficult to accurately detect crowd density with a general camera due to low illumination, and therefore an infrared (IR) camera or a thermal imaging camera may be used to analyze body temperature distributions and a movement pattern of a crowd.

According to an embodiment, the acquired image data may be transmitted to the control server 100 and analyzed in real time, and the control server 100 may perform an operation of assessing the crowd density, the movement pattern, and the abnormal behavior based on the corresponding data.

According to an embodiment of the present invention, the crowd density detection and accident prevention method may include generating the risk level determination information based on the image data.

In an embodiment, the generation of the risk level determination information may be performed by transmitting the image data acquired from the drone device 200 to the control server 100, and then analyzing the corresponding image data to comprehensively assess the crowd density, the movement pattern, whether there is congestion, the emotional state, etc.

For example, the control server 100 may calculate the crowd density per unit square meter within the specific zone based on the image data, and when the calculated value exceeds a preset threshold value, adjust the risk level of the corresponding zone upward. In addition, the movement direction and speed of the crowd may be assessed through the image analysis to determine whether the congestion phenomenon occurs in the specific zone.

As another example, the risk level determination information may be generated by analyzing the emotional states and abnormal behaviors of individual crowds. For example, when the tension, anxiety, and fear responses of the crowd are found to be increasing by utilizing a facial recognition and emotion analysis algorithm, the risk level of the corresponding zone may be dynamically adjusted. In addition, when a specific individual in the crowd exhibits a sudden change in direction, a rapid speed change, or an unpredictable behavior, the crowd may be classified as an abnormal behavior crowd and the risk level of the corresponding area may be immediately adjusted upward.

In an embodiment of the present invention, the risk level determination information is not simply generated based on the crowd density, but may be determined more precisely by reflecting the environmental factors and the real-time crowd behavior analysis results. For example, when external environmental factors such as illumination change, noise surge, and floor vibration are detected, the information may be added to the risk determination process to enable more dynamic risk level adjustment.

In addition, the risk level determination information may be generated by considering a correlation with adjacent zones as well as analysis results for a single zone. For example, when the crowd density increases rapidly near an entrance, the risk levels of not only the corresponding zone but also adjacent passageways may be adjusted together to more effectively perform the evacuation route guidance.

According to an embodiment of the present invention, the method for detecting crowd density and preventing accidents may include determining a response level based on the risk level determination information (S300).

In an embodiment, the determination of the response level may be performed by analyzing the risk level determination information generated by the control server 100 to comprehensively assess the crowd density state, the movement pattern, the emotional state, and the external environmental factors and then determine the response measures appropriate for the assessment.

For example, when the risk level determination information corresponds to a “minor risk” level, the drone device 200 may respond by providing a visual signal through an LED warning light and informing the crowd of the density using the information display unit. On the other hand, when the risk level is determined as a “medium risk” or higher, the drone device 200 may respond by performing the evacuation route guidance through the directional speaker or restricting the entry/exit into the specific zone.

In addition, when the risk level is assessed as “high risk” or “urgent risk,” the control server 100 may command the plurality of drone devices 200 to be cooperatively arranged and perform the precise detection, and transmit a warning notification to the user terminal 300 to perform the evacuation guidance in real time. For example, when the crowd density exceeds the threshold value, and at the same time, a large number of people exhibit anxiety or fear responses as a result of the emotional state analysis, the drone device 200 may set the corresponding zone as a priority monitoring target and may be adjusted to output the immediate warning signal.

According to an embodiment of the present invention, the response level may not be fixed, but may be dynamically adjusted according to the real-time change in the risk level determination information. For example, in the zone that is initially determined as a “minor risk” and where only the visual guidance is provided, when the crowd density further increases and the congestion occurs within a certain period of time, the response level may be automatically adjusted upward to the “medium risk” or the “high risk.” Conversely, when the crowd density decreases and the movement becomes smooth, the response level may be gradually adjusted downward.

In the process of determining the response level, the cause and spread possibility of the risk factor may also be considered. For example, when a large number of people gather at an entrance and the density increases, the control server 100 may assess the risk of not only the corresponding zone but also the adjacent passageways, and if necessary, perform preemptive response measures even in the adjacent zones.

According to an embodiment of the present invention, the crowd density detection and accident prevention method may include generating the warning control signal corresponding to the response level (S400).

In an embodiment, the generation of the warning control signal may be performed by generating a signal in the control server 100 and transmitting the generated signal to the drone device 200 and the user terminal 300 so that the appropriate warning method may be applied according to the risk level determined in the response level determination operation (S300).

For example, when the risk level is determined as “minor risk,” the drone device 200 may provide a visual signal through the LED warning light and issue a warning by informing the crowd of the crowded state and movement direction through the information display unit (display panel). On the other hand, when the risk level is determined as “medium risk” or higher, the drone device 200 may provide guidance on the evacuation route by voice through the directional speaker or transmit the evacuation notification to the user terminal 300.

In addition, when the risk level is assessed to be “high risk” or “urgent risk,” the control server 100 may perform control such that a cooperative surveillance mode is activated for the plurality of drone devices 200 and the warning signal output within the corresponding zone increases. For example, when the crowd density in the specific zone increases rapidly and the emotion analysis result shows that a large number of people exhibit anxiety or fear, the drone device 200 may immediately change the color of the LED warning light, perform repeated warning broadcasts through the directional speaker, and provide the evacuation route guidance to the user terminal 300 in real time.

According to an embodiment of the present invention, the warning control signal may be dynamically adjusted according to the crowd density situation that changes in real time, beyond the simple warning notification. For example, in the zone where only the visual guidance was initially provided, when the crowd density further increases and the congestion occurs within a certain period of time, the intensity of the warning signal may increase, and the voice guidance and notification transmission to the user terminal 300 may be added. Conversely, when the crowd density gradually decreases, the intensity of the warning signal may be lowered, and the guidance information may be updated, if necessary.

In an embodiment, the spread possibility of the risk factors may also be considered in the process of generating the warning control signal. For example, when the crowd is dense at a specific entrance and the risk level increases, the control server 100 may transmit a warning signal not only to the corresponding zone but also to adjacent movement routes, thereby inducing the crowd to select a safe alternative route.

According to an embodiment of the present invention, the drone device 200 may include the information display unit. The information display unit includes the display panel and the light emitting diode (LED) warning light for providing the visual warning and the evacuation guidance signal to the crowd according to the risk level determination information.

The information display unit intuitively displays the crowd density state by using the color change according to the risk level through at least one of the display panel and the LED warning light, and visually provides the evacuation direction or the safety zone information.

For example, referring to FIG. 2, the display panel of the drone device 200 may change a color to “safe (green)” when the crowd density is low, “warning (yellow)” when caution is required, and “danger (red)” when an urgent risk is detected, so that the crowd may easily recognize the risk level. In addition, real-time information such as “movement direction: left exit,” “current zone density: 90% (danger),” and “evacuation route guidance: move to south exit” may be provided through the display panel.

That is, the display panel may provide appropriate information to the crowd in the form of text, icons, or animations to perform quick and effective evacuation guidance. For example, when the designated evacuation route is crowded, an alternative route may be updated and provided in real time, and the guidance information may also be dynamically changed as the drone device 200 moves.

In addition, the LED warning light has strong brightness so that it may be recognized from a distance, and may blink in a certain pattern to further emphasize the warning signal. For example, when the congestion at the entrance increases, the drone device 200 may quickly blink the LED warning light to induce people to refrain from using the corresponding entrance.

According to an embodiment of the present invention, the information display unit may provide the guidance information dynamically by reflecting the real-time movement pattern of the crowd and the evacuation route information, beyond the simple warning display function, thereby enabling the crowd to avoid the danger more efficiently.

In an embodiment, the drone device 200 may include the directional speaker unit that outputs the voice information for the movement and evacuation guidance of the crowded area and each partitioned individual zone.

The directional speaker unit may detect the crowd density and the environmental noise level in real time, automatically adjust the sound output intensity, and dynamically adjust the direction of the sound output in response to the movement route of the crowd.

For example, when the crowd rapidly becomes dense in the specific zone, the directional speaker unit of the drone device 200 may output announcement broadcasts such as “This zone is very crowded. Please evacuate through the right exit,” toward the corresponding zone. On the other hand, when the crowd disperses, unnecessary warning broadcasts may be stopped or the volume may be automatically reduced to prevent confusion.

In addition, the directional speaker unit may analyze the movement direction of the crowd beyond the simple voice output function, and transmit the announcement broadcasts only to the specific zone. For example, when one entrance is closed or a specific passageway is overcrowded, the voice message such as “This passageway is crowded. Please move in the opposite direction,” may be transmitted only to the crowd trying to pass through the zone.

In this way, the directional speaker unit may be operated by accurately providing necessary information to the specific zone or a moving crowd, rather than omnidirectional broadcasts targeting the entire crowd. Accordingly, it is possible to prevent the occurrence of unnecessary noise, improve the accuracy of the evacuation guidance, and support moving the crowd more efficiently.

According to an embodiment of the present invention, the directional speaker unit may adjust the sound output intensity through the real-time data analysis and automatically update the announcement broadcast content when necessary, enabling flexible response to the change in the crowd state. Accordingly, it is possible to minimize confusion in the crowded area and enable faster and perform more effective accident prevention and evacuation guidance.

In an embodiment, the control server 100 may include an analysis module that generates the risk level determination information based on the image data.

The analysis module may be implemented through some of a plurality of processors, and each processor may perform various analysis functions including the crowd density analysis, the movement pattern detection, the emotional state assessment, and the environmental change detection.

For example, some processors may process the image data acquired from the drone device 200 in real time to assess the crowd density, and other processors may analyze the movement speed, direction, whether there is congestion, etc., of individual crowds to predict the crowd flow. In addition, the specific processor may analyze the emotional state based on the facial expressions and physical movements to detect the tension, fear, or panic state, and another processor may process environmental sensing information to assess external factors such as the illumination change, the increased noise, and the vibration detection.

The analysis module may be executed centrally within the control server 100, and if necessary, distributed to and processed in individual processors. For example, when the high-speed processing is required, a computational load may be distributed in such a way that the specific processor preferentially performs the crowd density analysis and other processors perform the emotion analysis and risk level determination in a later operation.

In addition, when the plurality of processors operate in parallel, a quick determination may be made even when the risk level increases rapidly in the specific zone, and the warning signal may be generated in real time, if necessary.

According to an embodiment, the analysis module may include the object detection and crowd flow analysis unit that identifies the individual objects in the crowd in the image data and analyzes the movement route and congested zone.

In an embodiment, the object detection and crowd flow analysis unit may identify individuals in the crowd and extract their location, speed, and direction information using a deep learning-based object detection algorithm. For example, a convolutional neural network (CNN)-based detection technology such as You Only Look Once (YOLO) or faster R-CNN may be used to simultaneously track multiple individuals and analyze behavioral patterns of each.

In addition, in order to analyze the movement route of the crowd, movement vectors of the individuals may be generated, and the change in the crowd density within the specific zone may be tracked in real time based on the generated movement vector. For example, the case where a large number of people are concentrated in a specific direction around an intersection or an entrance may be detected in real time, and the time when the corresponding zone reaches the congested state may be predicted.

In an embodiment, the object detection and crowd flow analysis unit may also perform a function of identifying a crowd congested zone. For example, when the movement speed of the crowd in the specific zone is maintained at a threshold value or less, or when the same location is congested with a large number of people for a certain period of time or longer, the corresponding zone may be classified as a “congested zone.”

According to an embodiment of the present invention, the object detection and crowd flow analysis unit may analyze not only the movement of individuals, but also the collective movement of crowd groups. For example, it may assess whether the crowd flow is naturally distributed or whether a bottleneck phenomenon occurs in the specific zone, and the drone device 200 and the control server 100 may adjust the warning signal based on the assessment so that the crowd may be effectively dispersed.

In addition, the object detection and crowd flow analysis unit may assess the risk of the specific zone by comparing the movement direction and density of the crowd. For example, the case where the crowd is excessively concentrated in one direction on a ramp or narrow entrance may be determined as the risk factor and the warning signal for showing an alternative route may be activated.

In addition, the analysis module may include a density assessment unit that quantitatively calculates the crowd density and generates the density information by assessing whether the risk threshold value is exceeded in the specific zone.

In an embodiment, the density assessment unit may perform a more precise density assessment by comprehensively considering a distribution pattern, spatial constraints, and movement possibility, etc., of a crowd, rather than simply calculating the crowd density based on the total number of individuals.

For example, the density assessment unit may estimate an area of the specific zone from image data and calculate people per unit square meter (PPD) to quantitatively assess the crowd density. Accordingly, it is possible to quantify how densely the crowd is packed within the specific zone and compare the quantified value with the preset threshold value to determine whether the zone corresponds to any of a “safe,” “warning,” or “risk” stage.

In addition, the density assessment unit may adjust the density information by considering the environmental factors as well as calculating the population density. For example, in spaces such as narrow passageways, entrances, exits, and ramps, the density may be more dangerous even with the same number of people, so the risk threshold value may be set differently depending on the spatial characteristics.

In addition, it is possible to detect whether the crowd is congested and correct the density information. For example, the case where the crowd moves at a constant speed without causing congestion may be assessed as a relatively low risk, but if a large number of people remain in the congested state even at the same density, the risk level may be adjusted upward because the risk of accidents may increase.

In other words, the density assessment unit may perform a dynamic assessment that reflects the speed of increase in density and the direction of crowd flow by analyzing changes over time rather than assessing the density at a specific moment. For example, the case where the rapid increase in density is detected in the specific zone within a short period of time may be determined as an immediate risk factor, and the warning signal may be strengthened.

In addition, the density assessment unit may perform more precise determinations by being linked to other analysis functions. For example, by combining data from the object detection and crowd flow analysis unit, the density risk may be automatically adjusted upward when the crowd congestion phenomenon continues in the specific zone, and by combining data from the emotional state analysis unit, the risk may be adjusted if the fear response increases in the crowd.

According to an embodiment of the present invention, the density assessment unit comprehensively considers the movement characteristics, spatial constraints, environmental factors, temporal changes, etc., of the crowd to enable more sophisticated crowd density analysis, thereby enabling more effective accident prevention and response.

In addition, the analysis module may include an emotional state analysis unit that analyzes facial expressions and physical movements of individuals to generate emotional state information.

In an embodiment, the emotional state analysis unit may detect emotional changes of individuals in the crowd in real time by utilizing a facial recognition and emotional analysis algorithm. For example, a deep learning model based on a convolutional neural network (CNN), a recurrent neural network (RNN), or a transformer may be applied to analyze the facial expressions of the individuals, and emotional states such as “calm,” “tension,” “fear,” “confusion,” and “anger” may be classified based on the analyzed facial expressions.

In addition, the emotional states may be more precisely assessed through the physical movement analysis. For example, sudden increases in movement, rapid direction change, crouching postures, and behaviors such as looking around may indicate that the crowd is feeling tension or fear. By analyzing such physical movement data, a more sophisticated risk level combined with the emotional states may be calculated.

In an embodiment, the emotional state analysis unit may track changes in emotional data over time to assess collective changes in emotional states within the specific zone. For example, when the tension of the crowd gradually increases over a certain period of time or the fear response increases rapidly in the specific zone, the corresponding zone may be classified as a “psychological risk zone” and it may be determined that immediate response is necessary.

In addition, the emotional state analysis unit may assess a more comprehensive risk level by combining the crowd density and the movement patterns. For example, the case where a large number of people exhibit anxiety or fear responses in an area with high crowd density may be determined as a “panic risk” state and an immediate warning signal may be sent or the evacuation guidance may be strengthened using the drone device 200.

According to an embodiment of the present invention, the emotional state analysis unit may detect not only the emotional analysis of the individuals, but also patterns of collective spread of emotional changes within the specific zone. For example, when some individuals in a crowd begin to exhibit fear responses, it is highly likely that psychological effects will spread to the surrounding people, leading to a state of panic, so this may be detected and responded to in advance.

In addition, the emotional state analysis unit may interpret the emotional changes in combination with the external environmental factors. For example, when the tension of the crowd increases rapidly after a loud noise (explosion, screaming, etc.) occurs, it is highly likely that the noise has acted as a factor inducing psychological anxiety in the crowd, so this may be reflected in the risk assessment.

In addition, the analysis module may include a risk level determination unit that integrates the density information and the emotional state information to predict the dynamic changes in the crowd and detect the abnormal patterns.

In the embodiment, the risk level determination unit may comprehensively assess the change in the crowd density, the movement patterns, the emotional states, and the environmental factors to calculate the risk level of the corresponding zone in real time. For example, not only when the crowd density of the specific zone is merely high, but also when the density increases rapidly, when the congestion phenomenon continues, or when the crowd suddenly gathers in a specific direction, the corresponding zone may be determined as a “risk zone.”

In addition, the risk level determination unit may immediately adjust the risk level of the corresponding zone upward when the tension and fear responses within the crowd increase by reflecting the emotional state analysis results. For example, when a crowd shows behavior of anxiously scanning surroundings while reducing its movement speed, and when a certain number or more of people suddenly change their direction of movement in the specific zone, this may be detected as an early sign of panic spreading and preemptive measures may be taken.

In various embodiments, the risk level determination unit may not only perform the risk assessment in real time, but also predict risks that may occur in the future based on past data and pattern analysis. For example, when a pattern of periodic increases in density is detected in the specific zone or when a similar congestion phenomenon occurs at a location where a past accident has occurred, this may be automatically analyzed to increase the risk level of the corresponding zone in advance.

In addition, the risk level determination unit may comprehensively consider a plurality of risk factors and perform a multi-criteria-based risk assessment. For example, it may differentially assess the case where the crowd density is high but the movement is smooth and the case where the crowd density is relatively low but the fear response spreads, enabling more precise risk level determination.

According to an embodiment, the risk level determination unit may adjust the risk by considering not only the specific zone but also the correlation with adjacent zones. For example, when the congestion occurs near the entrance, the risk of not only the entrance but also the connected passageway may be assessed together, and an alternative entrance may be indicated or a dispersion induction strategy may be applied so that the crowd does not concentrate in a specific direction.

According to an embodiment of the present invention, the risk level determination unit comprehensively analyzes various factors such as the emotional state, the movement pattern, the congestion duration, and the environmental changes, beyond a simple crowd density-based assessment, enabling more precise crowd safety management. Accordingly, it is possible to detect the possibility of occurrence of an accident early, and perform a more effective response.

According to an embodiment, the control server 100 may include a flight pattern control unit that adjusts a flight pattern of the drone device 200 in a specific crowd area in real time based on the risk level determination information.

The flight pattern control unit may control the drone device 200 to switch to a low-altitude flight mode to perform precision detection when the density information corresponding to the specific zone exceeds the preset threshold value, control the drone device 200 to hover at a fixed location within a safe distance when it is identified that the tension and fear response of the crowd increases rapidly based on the real-time change in the emotional state information corresponding to the image data acquired during the performance of the precision detection, and control the drone device to continuously perform additional image data collection in the corresponding zone when the analysis results of the image data collected in the low-altitude flight and hovering state show that the crowd density continuously increases or the congested state is maintained for a certain period of time.

Specifically, the flight pattern control unit dynamically adjusts the flight pattern of the drone device 200 by reflecting the real-time changing crowd density and emotional state information, thereby enabling more precise surveillance and response.

In the embodiment, the flight pattern control unit may control the drone device 200 to switch to the low-altitude flight mode in order to detect the corresponding zone more precisely when the crowd density of the specific zone exceeds the preset threshold value. Accordingly, the drone device 200 may detect the individuals in the crowd at a closer distance and analyze the movement patterns, the congested zones, and the risk factors more accurately.

In addition, when the tension and fear response of the crowd increases rapidly in the image data acquired during the precision detection, the flight pattern control unit may control the drone device 200 to hover at the fixed location within the safe distance. This is to minimize unnecessary movement so that the crowd does not feel anxious, and at the same time, to maintain the continuous surveillance of the corresponding zone. For example, when the crowd suddenly stops moving at a specific point or suddenly changes a direction, the drone device 200 may immediately switch to a hovering mode to continuously analyze the corresponding situation, and if necessary, send the warning signal.

In addition, when the analysis results of the image data collected in the low-altitude flight and hovering state show that the crowd density is continuously increasing or the congested state is maintained for a certain period of time, the flight pattern control unit may control the drone device 200 to continuously perform additional image data collection in the corresponding zone. Accordingly, it is possible to analyze the movement trend of the crowd more precisely and perform the quick response when the crowd does not safely disperse.

That is, the flight pattern control unit does not simply maintain a fixed flight route, but adjusts the flight pattern of the drone device 200 in real time according to the crowd density situation, and if necessary, performs control such that precise detection and continuous data collection are performed, thereby enabling more effective accident prevention and crowd management.

According to an embodiment, the density assessment unit may dynamically adjust the risk threshold value for assessing the crowd density according to the environmental factors.

Here, the environmental factors may include spatial density that involves identifying the individuals in the crowd in the image data and calculating the PPD based on the area of the zone where the crowd is located, obstacle influence that involves assessing a degree to which the movable route of the crowd is restricted by analyzing the location, size, and width of the obstacle, terrain slope information that involves analyzing a terrain slope of the zone where the crowd is located and adjusting a risk when the terrain slope is a certain slope or more, and escape possibility information that involves assessing the possibility of risk avoidance of the crowd by analyzing whether the entry and evacuation route is secured.

In detail, among the environmental factors various spatial, topographic, and structural elements may be considered to more precisely adjust the reference for quantitatively assessing the crowd density.

First, the spatial density may be an element that assesses the density based on the PPD of the zone where the crowd is located. In an embodiment, the density assessment unit may identify individuals detected in the image data and calculate the PPD by analyzing the area of the corresponding zone. Accordingly, it is possible to analyze the actual crowd density state more precisely compared to the space, rather than simply based on the total number of people. For example, when there are 100 people in a large plaza and the same number of people are located near a narrow entrance, the latter may have a higher risk even with the same number of people.

In addition, the obstacle influence may act as a factor that limits the possible movement route of the crowd. In an embodiment, the density assessment unit may analyze the location, size, and width of obstacles (e.g., pillars, walls, structures, vehicles, etc.) in the image data to assess the movement possibility of the crowd in the corresponding zone. For example, in the narrow passageway with many obstacles, the risk of accidents is likely to increase because the movement is restricted even with the same density. Accordingly, the risk of the corresponding zone may be adjusted according to the arrangement state of obstacles.

The terrain slope information may be used as a risk adjustment factor by analyzing the slope of the zone where the crowd is located. For example, unlike a flat road, in a zone with a ramp or stairs, when the crowd density exceeds a certain level, the risk of tripping or falling accidents may increase. In an embodiment, the density assessment unit may analyze the image data to calculate the slope of the terrain, and when a certain slope is detected, the risk threshold value of the zone may be adjusted downward. For example, in a slope of 10° or more, the risk level may be assessed as high even if the crowd density exceeds a certain level, and in a zone with a steep slope, the evacuation guidance may be strengthened considering the possibility of an accident even if the number of people is small.

In addition, the escape possibility information may be a factor for assessing how quickly the crowd may escape from the zone when a dangerous situation occurs. In an embodiment, the density assessment unit may assess the escape possibility of the zone by analyzing the number of entrances and exits, the number of emergency exits, the number of evacuation routes, and accessibility. For example, when there is only one entrance or some entrances and exits are closed, the risk level may be adjusted upward because the escape possibility is lowered even at the same density. On the other hand, in a zone where a plurality of evacuation routes are secured, the risk level may be assessed as relatively low.

According to an embodiment of the present invention, the density assessment unit does not evaluate density solely by considering the number of people, but comprehensively analyzes various environmental factors such as the spatial density, the obstacle influence, the terrain slope information, and the escape possibility information to enable more precise risk assessment. Accordingly, it is possible to evaluate the dynamic density assessment that reflects the movement possibility of the crowd and the spatial constraints and perform more effective crowd safety management and accident prevention.

According to an embodiment, the risk level determination unit may classify a plurality of crowd groups having different properties based on the individual movement patterns of the crowd within the same zone.

According to an embodiment, the plurality of crowd groups may include a moving crowd group including a crowd moving in the same direction at a constant speed, a congested crowd group including a crowd that is congested at a specific point or remains in a high-density state for a certain period of time, the abnormal behavior crowd group including a crowd that exhibits a sudden change in direction, an irregular change in speed, or an unpredictable movement compared to a previous movement route, and an individual crowd group including a crowd that moves individually while away from other crowds by a certain distance or more.

In an embodiment, the risk level determination unit may apply different risk levels to each of the plurality of crowd groups, and when a specific crowd group is determined to have a relatively high risk compared to the entire crowd, may preferentially monitor the corresponding crowd group or adjust the flight pattern of the drone device 200.

More specifically, the risk level determination unit may analyze the characteristics and dynamic changes of each crowd group in real time to precisely assess the condition and risk of the crowd.

In an embodiment, the moving crowd group includes a crowd moving in the same direction at a constant speed, and may be assessed as a relatively low risk when it maintains a normal flow. However, when the moving speed is rapidly decreases or the density increases at a specific point, the risk level of the corresponding zone may be adjusted upward. For example, when the speed of the moving crowd group is rapidly decreases at an entrance or a narrow passageway, the corresponding zone may be classified as a dangerous area because there is a high possibility of occurrence of collision or a congestion phenomenon due to the density.

In the case of the congested crowd group, it may include a crowd that is congested or maintains a high density at a specific point for a certain period of time. For example, when a large number of people stay in front of an entrance, on a stage, or near an event zone for a long period time, the risk may be assessed as high because evacuation may be difficult in the event of an emergency. Accordingly, the risk level determination unit may continuously monitor the corresponding zone and activate a warning signal when the congested state continues.

The abnormal behavior crowd group may include a crowd that exhibits a sudden change in direction, an irregular change in speed, or unpredictable movement compared to the previous movement route. For example, the case where a person suddenly runs in a specific direction at a high speed or moves in the opposite direction of the crowd may be considered a precursor to the occurrence of accidents or panic. When such an abnormal behavior is detected, the risk level determination unit may preferentially monitor the corresponding crowd group, and if necessary, include the drone device arranged in the zone to perform additional monitoring and warning broadcasts.

The individual crowd group may include crowds moving individually away from other crowds by a certain distance or more. Such crowds may generally be assessed as a low risk, but may have an exceptionally high risk in a certain environment. For example, when a crowd moving individually is detected near a dangerous area (cliff, waterway, etc.), the risk level of the corresponding zone may be adjusted because the risk of falling may increase.

In addition, the risk level determination unit may perform a comprehensive risk assessment by analyzing the interaction between crowd groups. For example, when the abnormal behavior crowd increases within the congested crowd group, the risk of the corresponding zone may be adjusted upward suddenly as the possibility of panic may increase.

According to an embodiment, when the control server 100 detects that the risk level determination information is greater than the reference threshold value, the control server 100 may generate the evacuation route information based on map information related to an area where the crowd is located and location information of the drone device, and dynamically correct the evacuation route information based on the risk levels of each of the plurality of classified crowd groups.

Specifically, the control server 100 may comprehensively analyze map information of the area where the crowd is located and real-time location information of the drone device 200 when the risk level determination information exceeds the preset reference threshold value to generate the optimal evacuation route information.

Here, the map information of the area is data including spatial characteristics and possible movement routes of a specific area where the crowd is located, and may be utilized to efficiently set the evacuation route and ensure the safe movement of the crowd.

In an embodiment, the map information may include information on the terrain structure, building layout, entrance, and main passageway of the corresponding area. For example, in a densely populated space such as a complex facility, a stadium, a shopping mall, or a public square, various movement routes such as entrances and exits, stairs, elevator locations, and underground passageways may be pre-stored to generate the evacuation route so that the crowd may be dispersed rather than being concentrated on a specific route.

According to an embodiment, the evacuation route information may not simply provide a route through which the crowd may move the fastest, but may be dynamically corrected by considering the risk levels of the plurality of classified crowd groups. For example, a route may be provided through which the moving crowd group may evacuate smoothly, but a route may be set that detours a zone where the congested crowd group is located to prevent a bottleneck phenomenon.

In addition, when the abnormal behavior crowd group is detected on a specific route, the evacuation route may be modified to avoid the corresponding zone, or the drone device may be arranged in the corresponding zone to strengthen the real-time monitoring. For example, when the abnormal behavior crowd group exhibits the unexpected direction change or the irregular change in speed within the evacuation route, the evacuation route may be changed to reflect the unexpected direction change or the irregular change in speed, or the corresponding zone may be monitored preferentially.

The control server 100 may continuously monitor the changes in the crowd density in each zone so that the evacuation route may be updated in real time, and when the bottleneck phenomenon occurs in the specific zone, automatically generate and provide guidance on an alternative route. For example, when an initial evacuation route is set to entrance A, but the density of the corresponding zone increases rapidly, a detour route to entrance B or C may be immediately reflected and indicated.

In addition, the control server 100 may also adjust the evacuation route information by reflecting the environmental factors. For example, when the density increases on a ramp near the entrance, the evacuation route may be adjusted so that the crowd may move safely, or when noise or vibration is detected in the specific zone, the route may be modified to avoid the corresponding route.

According to an embodiment of the present invention, the control server 100 assesses the risk levels for each crowd group in real time and continuously corrects the evacuation route information by reflecting the assessment, thereby enabling more effective crowd management and accident prevention. Accordingly, it is possible to optimize the evacuation speed in the congested area and minimize the possibility of occurrence of accidents.

Further, in an embodiment, the risk level determination unit may analyze the movement speed change, the congestion duration, and the behavioral patterns of each crowd group in real time, and when it is identified that at least one of a plurality of conditions is satisfied, increase a risk level of a specific area.

In this case, the plurality of conditions may include a first condition in which the speed reduction rate of the moving crowd group exceeds a preset threshold speed reduction rate, a second condition in which the congested crowd group remains at the same location for a preset period of time or longer, and a third condition in which an irregular change in speed or an abrupt direction change is detected within the moving crowd group or the individual crowd group to detect switching to the abnormal behavior crowd group.

Specifically, the risk level determination unit may analyze the movement characteristics of the crowd group in real time, detect the possibility of accidents that may occur in the specific zone in advance, and dynamically adjust the risk level.

In an embodiment, when the speed reduction rate of the moving crowd group exceeds a preset threshold speed reduction rate (first condition), it is determined that there is a high possibility of congestion or crowd density in the corresponding zone, and therefore the risk level may be increased. For example, when the speed of the moving crowd group suddenly decreases in a zone where it was moving normally, there is a high possibility that an obstacle will occur in the corresponding zone or unexpected congestion will occur, and therefore the risk level may be adjusted to reflect that possibility. In particular, when the speed reduction continues or occurs repeatedly in the specific zone, the corresponding zone may be classified as a risk zone, and additional monitoring and warning signal provision may be performed using the drone device 200.

In addition, when the congested crowd group remains in the same location for a preset period of time (second condition), it may be determined that the movement of the crowd is blocked or the possibility of an accident has increased and the risk level may be adjusted upward. For example, when a certain location is congested with a large number of people for a long period of time, such as a performance hall entrance, a subway station platform, or a stadium entrance, the risk of occurrence of crushing or panic may increase. Accordingly, the risk level determination unit may monitor the congestion duration of the zone in real time and activate the immediate warning signal if no movement is detected for a certain period of time.

The case where an irregular change in speed or a sudden change in direction is detected within the moving crowd group or the individual crowd group, and switching to the abnormal behavior crowd group is detected (three conditions) may be determined as an initial signal of panic or sudden behavior within the crowd and the risk level may be increased. For example, when a normally moving crowd suddenly runs or moves rapidly in the opposite direction, there is a high possibility that an unexpected event (explosion, accident, physical collision, etc.) has occurred in the zone, and this may be detected and responded to immediately.

In addition, the risk level determination unit may increase the risk level of the zone more quickly when a plurality of conditions are met at the same time. For example, the case where a crowd group remains congested for a certain period of time and some individuals suddenly exhibit an abnormal behavior may be interpreted as an initial sign of large-scale confusion (e.g., crowd panic) and the rapid warning and the evacuation guidance measures may be performed.

According to an embodiment of the present invention, the risk level determination unit does not simply analyze the current state, but comprehensively considers the movement speed, the congestion duration, the abnormal behavior, etc., to detect the risk that may occur in the crowded area in advance and respond quickly. Accordingly, it is possible to more effectively perform the accident prevention and crowd safety management, and optimize the real-time monitoring and warning functions by being linked to the drone device 200.

According to an embodiment, the risk level determination unit may analyze the movement speeds, the movement directions, the physical movements, and the emotional states of the individuals in real time to detect an abnormal crowd exhibiting abnormal behavior, track the movement route of the abnormal crowd, and dynamically adjust the risk level of the zone where the abnormal crowd is located according to the state of the abnormal crowd.

More specifically, the risk level determination unit may analyze the behavioral patterns of the individuals in real time, detect a crowd exhibiting abnormal behavior (hereinafter referred to as “abnormal crowd”) within the specific zone, track the movement route of the corresponding crowd, and dynamically adjust the risk level of the zone as needed.

In the embodiment, the risk level determination unit may analyze the changes in movement speed of the individuals to identify a crowd that deviates from normal movement patterns as an abnormal crowd. For example, the case where the crowd that is moving at a certain speed in the specific zone suddenly increases (runs) or decreases (suddenly stops) its speed may be determined as an abnormal behavior. In particular, the case where multiple crowds exhibit the rapid change in speed at the same time may be detected as an initial signal of crowd panic, enabling an immediate response.

In addition, the movement direction change may also be an important factor in detecting the abnormal crowd. For example, when multiple crowds are moving in one direction, the case where a specific individual crowd suddenly moves in the opposite direction or deviates to an unexpected route may be determined as the abnormal behavior. When such a crowd repeatedly deviates from the specific route or performs the irregular direction change, the risk level may be adjusted by determining that the corresponding crowd is likely to cause an accident or reacts to a specific threat factor (e.g., explosion, collision, etc.).

Additionally, the abnormal crowd behavior may be detected more precisely through the physical movement analysis. For example, unlike a general walking pattern, the case where a specific crowd suddenly sits down or crouches down may be interpreted as a reaction to an external stimulus (such as an explosion, accident, or collision). Conversely, the case where a specific crowd exhibits aggressive behavior (such as jumping, swinging arms, etc.) toward another crowd may be determined as a sign of occurrence of a conflict between crowds, allowing for prompt intervention.

In addition, the psychological changes in individuals may be detected through the emotional state analysis, which may be reflected in the risk level determination. In an embodiment, the risk level determination unit may analyze the facial expressions of the individuals detected from the image data, and assess the emotional changes such as tension, fear, and anger in real time. For example, the case where the number of people making anxious expressions suddenly increases within a crowd may be detected as a signal that the possibility of occurrence of crowd panic is increasing, and the risk level may be adjusted.

The risk level determination unit may track the movement route of the abnormal crowd, and additionally adjust the risk level when the corresponding crowd deviates from the specific area or approaches the crowded area. For example, the case where the abnormal crowd moves quickly toward an entrance where a large number of people are gathered may be determined as an increased risk factor for an accident, and therefore the risk level of the corresponding zone may be immediately adjusted upward. According to an embodiment of the present invention, the risk level determination unit comprehensively analyzes the movement speed, the direction changes, the physical movements, and the emotional states of the individuals, thereby enabling more precise risk detection and response than the existing crowd density-based assessment method. Accordingly, it is possible to perform the more effective crowd management and accident prevention by reflecting the dynamic behavior changes of the individuals in real time rather than the simple spatial density.

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, or an assembler, including various algorithms implemented in a combination of data structures, processes, routines, or other programming constructions. Functional aspects may be implemented in algorithms executed on one or more processors.

Those skilled in the art will appreciate that various exemplary logical blocks, modules, processors, means, circuits, and algorithm steps described in connection with the embodiments disclosed herein may be implemented by electronic hardware, various forms of programs or design codes (referred to herein as “software” for convenience), or a combination thereof. To clearly describe this interchangeability of hardware and software, various exemplary components, blocks, modules, circuits, and steps have been generally described above in terms of their functionality. Whether these functions are implemented as hardware or software depends on the specific application and the design constraints imposed on the overall system. Those skilled in the art will appreciate that each particular application may implement the described functionality in a variety of ways, but such implementation decisions should not be interpreted as deviating from the scope of the present invention.

According to an embodiment of the present invention, a drone can be used to detect crowd density in real time, analyze the movement flow of a crowd and abnormal behaviors of individuals, and dynamically adjust a risk level to reflect environmental changes. Accordingly, it is possible to overcome the limitations of the existing fixed surveillance system, detect crowd density in a wider range, and enable real-time response.

In addition, according to the present invention, by analyzing movement patterns, directional changes, physical movements, and emotional states of individuals, beyond simple density assessment, it is possible to more precisely predict the possibility of an accident. Accordingly, it is possible to detect and track a crowd exhibiting abnormal behavior early, and when necessary, to adjust the risk of a zone where the crowd is located upward to enable additional warning and response.

Additionally, according to the present invention, by detecting environmental changes (illumination, noise, vibration, temperature, etc.) in real time and reflecting the environmental changes in risk level assessment of a crowd, it is possible to enable more sophisticated risk management. For example, when illuminance decreases rapidly, the risk can be adjusted upward by detecting a situation where it is difficult for the crowd to secure a field of view, and when noise increases rapidly, the emotional response of the crowd can be analyzed to detect the possibility of panic early.

In addition, according to the present invention, by generating an optimal evacuation route in real time according to risk level determination and automatically providing the detour route when necessary, it is possible to induce safe movement of a crowd. Unlike the existing system that provides guidance on a preset route, according to the present invention, by reflecting the movement flow of the crowd and changes in the surrounding environment to dynamically optimize the route, it is possible to enable more effective evacuation guidance.

The present invention can be applied to various fields such as accident prevention in crowded areas and at large-scale events, disaster response, crowd management in public places, and safety management of stadiums and performance halls, and support more precise control of movement flow of a crowd. Accordingly, it is possible to prevent accidents due to crowd density and create a safer environment.

Effects of the present invention are not limited to the effects described above, and other effects that are not mentioned may be obviously understood by those skilled in the art from the following description.

Various embodiments presented herein may be implemented as methods, devices, or manufactured articles using standard programming and/or engineering techniques. The term “manufactured article” includes a computer program, carrier, or media accessible from any computer-readable device. Examples of the computer-readable medium include but are not limited to magnetic storage devices (e.g., a hard disk, a floppy disk, a magnetic strip, etc.), optical discs (e.g., a compact disc (CD), a digital versatile disc (DVD), etc.), smart cards, and flash memory devices (e.g., EEPROM, card, stick, key drive, etc.). In addition, various storage media presented herein include one or more devices and/or other machine-readable media for storing information. The term “machine-readable medium” includes but is not limited to wireless channels and various other media capable of storing, retaining, and/or transmitting instructions(s) and/or data.

It is to be understood that a particular order or hierarchy of steps in presented processes is an example of exemplary approaches. It is to be understood that the specific order or hierarchy of steps in processes may be rearranged within the scope of the present invention, based on design priorities. The appended method claims provide elements of various steps in a sample order but are not meant to be limited to the particular order or hierarchy presented.

The description of the presented embodiments is provided to enable any person skilled in the art to make or use the present invention. Various modifications to these embodiments will be apparent to those skilled in the art, and the general principles defined herein may be applied to other embodiments without departing from the scope of the invention. Therefore, the present invention is not limited to the embodiments presented herein, but is to be construed in the broadest scope consistent with the principles and novel features presented herein.

What is claimed is:

1. A drone-based crowd density detection and accident prevention system, comprising:
a drone device that includes an image acquisition unit acquiring image data for detecting crowd density in real time; and
a control server that generates risk level determination information based on the image data collected by the drone device, determines a response level according to a real-time change in the risk level determination information, generates a warning control signal corresponding to the determined response level, and transmits the generated warning control signal to at least one of an external device and the drone device.

2. The drone-based crowd density detection and accident prevention system of claim 1, wherein the drone device includes an information display unit, and
the information display unit includes a display panel and a light emitting diode (LED) warning light for providing a visual warning and an evacuation guidance signal to a crowd according to the risk level determination information, and
intuitively displays a crowd density state by using a color change according to the risk level through at least one of the display panel and the LED warning light, and visually provides an evacuation direction or safety zone information.

3. The drone-based crowd density detection and accident prevention system of claim 1, wherein the control server includes an analysis module that generates the risk level determination information based on the image data, and
the analysis module includes:
an object detection and crowd flow analysis unit that identifies an individual in the crowd from the image data and analyzes a movement route and a congested zone;
a density assessment unit that quantitatively calculates the crowd density and generates density information by assessing whether a risk threshold value is exceeded within a specific zone;
an emotional state analysis unit that analyzes a facial expression and a physical movement of an individual to generate emotional state information; and
a risk level determination unit that integrates the density information and the emotional state information to predict a dynamic change in the crowd and detect an abnormal pattern.

4. The drone-based crowd density detection and accident prevention system of claim 3, wherein the control server includes a flight pattern control unit that adjusts a flight pattern of the drone device in real time in a specific crowd area based on the risk level determination information, and
the flight pattern control unit controls the drone device to perform precision detection by switching to a low-altitude flight mode when the density information corresponding to a specific zone exceeds a preset threshold value,
controls the drone device to hover at a fixed location within a safe distance when it is identified that a tension and fear response of the crowd rapidly increases based on the real-time change in the emotional state information corresponding to the image data acquired while the precision detection is performed, and
controls the drone device to continuously collect additional image data in a corresponding zone when the crowd density continues to increase or a congested state is maintained for a certain period of time, as a result of analyzing the image data collected in the low-altitude flight and hovering state.

5. The drone-based crowd density detection and accident prevention system of claim 3, wherein the density assessment unit dynamically adjusts a risk threshold value for assessing the crowd density according to environmental factors, and
the environmental factors include spatial density related to identifying an individual in the crowd from the image data and calculating people per unit square meter (PPD) based on an area of a zone where the crowd is located, obstacle influence related to assessing a degree to which a movable route of the crowd is restricted by analyzing a location, size, and width of an obstacle, terrain slope information related to analyzing a terrain slope of the zone where the crowd is located and adjusting a risk when the terrain slope is a certain slope or more, and escape possibility information related to assessing a possibility of risk avoidance of the crowd by analyzing whether an entry and evacuation route is secured.

6. The drone-based crowd density detection and accident prevention system of claim 3, wherein the risk level determination unit classifies a plurality of crowd groups having different properties based on an individual movement pattern of the crowd within the same zone,
the plurality of crowd groups include a moving crowd group that includes a crowd moving in the same direction at a constant speed,
a congested crowd group that includes a crowd that is congested at a specific point or remains in a high-density state for a certain period of time,
an abnormal behavior crowd group that includes a crowd that exhibits a sudden change in direction, an irregular change in speed, or an unpredictable movement compared to a previous movement route, and
an individual crowd group that includes a crowd that moves individually while away from other crowds by a certain distance or more, and
the risk level determination unit applies different risk levels to each of the plurality of crowd groups, and when a specific crowd group is determined to have a relatively high risk compared to the entire crowd, preferentially monitors the corresponding crowd group or adjusts the flight pattern of the drone device.

7. The drone-based crowd density detection and accident prevention system of claim 6, wherein, when the control server detects that the risk level determination information is greater than a reference threshold value, the control server generates evacuation route information based on map information related to an area where the crowd is located and location information of the drone device, and dynamically corrects the evacuation route information based on the risk levels of each of the plurality of classified crowd groups.

8. The drone-based crowd density detection and accident prevention system of claim 6, wherein the risk level determination unit analyzes a movement speed change, a congestion duration, and a behavioral pattern of each crowd group in real time, and when it is identified that at least one of a plurality of conditions is satisfied, increases a risk level of a specific area, the plurality of conditions including a first condition in which the speed reduction rate of the moving crowd group exceeds a preset threshold speed reduction rate, a second condition in which the congested crowd group remains at the same location for a preset period of time or longer, and a third condition in which the irregular change in speed or the sudden change in direction is detected within the moving crowd group or the individual crowd group and switching to the abnormal behavior crowd group is detected.

9. The drone-based crowd density detection and accident prevention system of claim 6, wherein the risk level determination unit analyzes a movement speed, a movement direction, a physical movement, and an emotional state of the individual in real time to detect an abnormal crowd exhibiting abnormal behavior, tracks a movement route of the abnormal crowd, and dynamically adjusts a risk level of a zone where the abnormal crowd is located according to a state of the abnormal crowd.

10. The drone-based crowd density detection and accident prevention system of claim 1, wherein the drone device includes a directional speaker unit that outputs voice information for movement and evacuation guidance of a crowded area and each partitioned individual zone, and
the directional speaker unit detects crowd density and an environmental noise level in real time, automatically adjusts sound output intensity, and dynamically adjusts a direction of a sound output in response to the movement route of the crowd.
